(19) United States
(12) Patent Application Publication
(10) Pub. No.: US 2018/0095404 A1
(43) Pub. Date: Apr. 5, 2018

(54) ELECTROPHOTOGRAPHIC PHOTOCONDUCTOR AND IMAGE FORMING APPARATUS

(71) Applicant: Konica Minolta, Inc., Tokyo (JP)

(72) Inventors: Toshiyuki FUJITA, Tokyo (JP); Mari UEDA, Tokyo (JP); Haruo HORIGUCHI, Tokyo (JP)

(21) Appl. No.: 15/724,806

(22) Filed: Oct. 4, 2017

(30) Foreign Application Priority Data
Oct. 5, 2016 (JP) 2016-197374

(51) Int. Cl. G03G 21/00; G03G 15/00; G03G 5/043; G03G 5/082; G03G 5/14

(52) U.S. Cl. CPC G03G 21/0082; G03G 15/751; G03G 5/144; G03G 5/08221; G03G 5/0433

(57) ABSTRACT

An electrophotographic photoconductor (photoconductor) according to the embodiment includes a conductive support, a photosensitive layer, and a protective layer. The protective layer is composed of a cured product as one body obtained by a radical reaction of a composition containing a radical polymerizable monomer having a radical polymerizable functional group, a metal oxide fine particle having a radical polymerizable functional group, and camphorquinone or a derivative thereof. The photoconductor is installed in an image forming apparatus equipped with a cleaning device for removing transfer residual toner on the photoconductor, and the cleaning device includes an elastic cleaning member disposed so that it can come into contact with the surface of the photoconductor.

### CROSS REFERENCE TO RELATED APPLICATIONS

This application is entitled to and claims the benefit of Japanese Patent Application No. 2016-197374, filed on Oct. 5, 2016, including description, claims, drawings, and abstract the entire disclosure is incorporated herein by reference in its entirety.

### BACKGROUND

### Technological Field

The present invention relates to an electrophotographic photoconductor and an image forming apparatus.

### Description of Related Art

An electrophotographic image forming apparatus, such as a printer, includes an electrophotographic photoconductor (hereinafter, also simply referred to as “photoconductor”) as a means of forming electrostatic latent images corresponding to desired images. To such a photoconductor, further extension of the lifetime is required. As the above-mentioned photoconductor, known is a photoconductor including a conductive support, a photosensitive layer disposed on the conductive support, and a protective layer disposed on the photosensitive layer, in which the protective layer is composed of a cured product as one body obtained by a radical reaction of a composition containing a radical polymerizable monomer having a radical polymerizable functional group, a metal oxide fine particle having a radical polymerizable functional group, and a charge transport agent (e.g., Japanese Patent Application Laid-Open No. 2013-061625 (hereinafter, “Patent Literature (PTL) 1”)). As for the photoconductor, efforts are made to enhance wear resistance of the protective layer and extend the lifetime by imparting reactivity with a monomer of a resin layer (which forms the protective layer) to the metal oxide fine particle.

In the photoconductor, the driving torque sometimes gradually increases depending on the operating environment and operating conditions, such as process conditions. Accordingly, there is a room for improvement in ensuring desired cleaning properties for a long period of time in conventional photoconductors.

A first object of the present invention is to provide an electrophotographic photoconductor having both excellent wear resistance and excellent cleaning properties.

A second object of the present invention is to provide an image forming apparatus that can achieve long-term stable formation of high-quality images.

### SUMMARY

As a means of achieving the first object, the present invention provides an electrophotographic photoconductor including: a conductive support; a photosensitive layer disposed on the conductive support; and a protective layer disposed on the photosensitive layer, in which the protective layer is composed of a cured product as one body obtained by a radical reaction of a composition containing: a radical polymerizable monomer having a radical polymerizable functional group; a metal oxide fine particle having a radical polymerizable functional group; and camphorquinone or a derivative thereof.

As a means of achieving the second object, the present invention provides an image forming apparatus including: the electrophotographic photoconductor; and a cleaner for removing transfer residual toner on a surface of the electrophotographic photoconductor, in which the cleaner includes an elastic material that comes into contact with the surface of the electrophotographic photoconductor.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an example of a configuration of an image forming apparatus according to an embodiment of the present invention; and

FIG. 2 schematically illustrates an example of a layered structure of an electrophotographic photoconductor according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

The electrophotographic photoconductor (photoconductor) according to the embodiment of the present invention includes a conductive support, a photosensitive layer disposed on the conductive support, and a protective layer disposed on the photosensitive layer. The photoconductor can be configured in substantially the same manner as a commonly known photoconductor, such as an organic photoconductor described in PTL 1, except for the protective layer described hereinafter.

The conductive support is a conductive member that can support the photosensitive layer. Examples of the conductive supports include a metal drum or sheet, a metal foil-laminated plastic film, a plastic film having a vapor-deposited conductive substance film, as well as a metal member, a plastic film, or a sheet of paper which has a conductive layer formed by applying a coating material containing a conductive substance and/or a binder resin. Examples of the metals include aluminum, copper, chromium, nickel, zinc, and stainless steel, and examples of the conductive substances include the above-mentioned metals, indium oxide, and tin oxide.

The photosensitive layer is a layer for forming a desired electrostatic latent image on the surface of the photoconductor through exposure described hereinafter. The photosensitive layer may be formed from a single layer or a plurality of laminated layers. Examples of the photosensitive layers include a single layer containing a charge transport compound and a charge generation compound, and a laminate of a charge transport layer containing a charge transport compound and a charge generation layer containing a charge generation compound.

The photoconductor may further include other component, in addition to the conductive support and the photosensitive layer, as long as the advantageous effects of the embodiment are obtained. Examples of such other components include an intermediate layer. The intermediate layer is, for example, a layer that is disposed between the conductive support and the photosensitive layer, and has a barrier function and a bonding function. Other layers can also be formed in substantially the same manner as those of a commonly known photoconductor, such as an organic photoconductor described in PTL 1.

The protective layer forms the surface of the photoconductor, and is also called a surface layer. The protective layer is composed of a cured product as one body obtained by a radical reaction of a composition containing a radical polymerizable monomer having a radical polymerizable functional group, a metal oxide fine particle having a radical polymerizable functional group, and camphorquinone or a derivative thereof. The protective layer includes, for example, a layer of a polymerized product obtained by a radical polymerization of the radical polymerizable monomer, the metal oxide fine particle dispersed/disposed in the layer and bonded with the polymerized product obtained by a radical reaction of the radical polymerizable functional group, and a camphorquinone derivative dispersed in the layer.

The radical polymerizable monomer is a compound having a radical polymerizable functional group. The radical polymerizable monomer may be one or more compounds, or an oligomer composed of a plurality of the bonded monomers. In view of hardness of the protective layer, the radical polymerizable monomer is preferably polyfunctional, i.e., having two or more radical polymerizable functional groups, and the number of the radical polymerizable functional groups of the radical polymerizable monomer is more preferably 2 to 6.

The radical polymerizable functional group is a functional group that is to be bonded by a radical reaction. The radical polymerizable functional group may be one or more groups. Examples of the radical polymerizable functional groups include an acryloyl group and a methacryloyl group.

The radical polymerizable monomer can be appropriately selected from commonly known radical polymerizable monomers. Examples of the radical polymerizable monomers include compounds below. In the formulae below, “R” represents an acryloyl group, and “R′” represents a methacryloyl group.

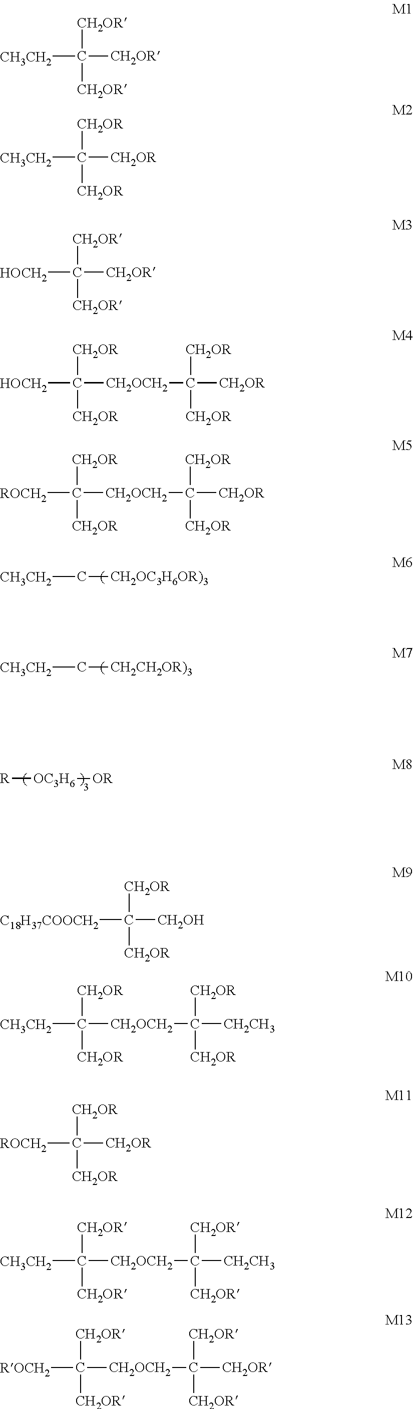

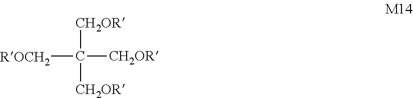

The metal oxide fine particle can be appropriately selected from commonly known metal oxide fine particles, as long as the advantageous effects of the embodiment are obtained. The metal oxide of the metal oxide fine particle may be a metal oxide described in PTL 1, for example. The metal oxide fine particle may be one or more types.

Examples of the metal oxides include silica (silicon oxide), magnesium oxide, zinc oxide, lead oxide, alumina (aluminum oxide), zirconium oxide, tin oxide, titania (titanium oxide), niobium oxide, molybdenum oxide, and vanadium oxide. Among them, tin oxide, titanium oxide, and zinc oxide are preferred.

The particle size of the metal oxide fine particle is preferably 1 to 300 nm, more preferably 3 to 100 nm, and further preferably 5 to 40 nm, as a number-average primary particle size. The number-average primary particle size of the metal oxide fine particle is obtained, for example, by taking an enlarged micrograph of the cross-section of the protective layer at a magnification of 10,000 times using a scanning electron microscope (from JOEL Ltd.), reading the enlarged micrograph by a scanner, analyzing images of 300 metal oxide fine particles randomly selected in the enlarged micrograph using a LUZEX AP automatic image analyzer (from NIRECO Corporation) with software version 1.32, and calculating a number-average primary particle size.

The metal oxide fine particle is preferably surface-treated with a surface treatment agent, from a viewpoint of enhancing dispersibility of the metal oxide fine particle in the protective layer, thereby enhancing wear resistance. Surface treatment of the metal oxide fine particle may be through physical support or chemical bonding of a surface treatment agent on the surface of the metal oxide fine particle. Such a surface-treated metal oxide fine particle has a cover layer on the surface. The cover layer is solely formed from the surface treatment agent in the case of surface treatment through the physical support, and formed from a chemical reaction product between the surface treatment agent and the surface of the metal oxide in the case of surface treatment through the chemical bonding.

The metal oxide fine particle is preferably surface-treated with a silane coupling agent having a radical polymerizable functional group, from a viewpoint of enhancing hardness of the protective layer as well as the above-mentioned viewpoint. By using a silane coupling agent having a radical polymerizable functional group as the surface treatment agent, the cover layer on the surface of the metal oxide fine particle and a radical polymer that forms the protective layer are chemically bonded by a radical reaction. Accordingly, such use of the silane coupling agent is preferred from a viewpoint of further strengthening the protective layer.

The silane coupling agent having a radical polymerizable functional group is preferably a silane coupling agent having an acryloyl group or a methacryloyl group. Examples of such silane coupling agents include the following compounds.

S-1: CH₂═CHSi(CH₃)(OCH₃)₂
S-2: CH₂═CHSi(OCH₃)₃
S-3: CH₂═CHSiCl₃
S-4: CH₂═CHCOO(CH₂)₂Si(CH₃)(OCH₃)₂
S-5: CH₂═CHCOO(CH₂)₂Si(OCH₃)₃
S-6: CH₂═CHCOO(CH₂)₂Si(OC₂H₅)(OCH₃)₂
S-7: CH₂═CHCOO(CH₂)₃Si(OCH₃)₃
S-8: CH₂—CHCOO(CH₂)₂Si(CH₃)Cl₂
S-9: CH₂═CHCOO(CH₂)₂SiCl₃
S-10: CH₂═CHCOO(CH₂)₃Si(CH₃)Cl₂
S-11: CH₂—CHCOO(CH₂)₃SiCl₃
S-12: CH₂═C(CH₃)COO(CH₂)₂Si(CH₃)(OCH₃)₂
S-13: CH₂═C(CH₃)COO(CH₂)₂Si(OCH₃)₃
S-14: CH₂═C(CH₃)COO(CH₂)₃Si(CH₃)(OCH₃)₂
S-15: CH₂═C(CH₃)COO(CH₂)₃Si(OCH₃)₃
S-16: CH₂═C(CH₃)COO(CH₂)₂Si(CH₃)Cl₂
S-17: CH₂═C(CH₃)COO(CH₂)₂SiCl₃
S-18: CH₂═C(CH₃)COO(CH₂)₃Si(CH₃)Cl₂
S-19: CH₂═C(CH₃)COO(CH₂)₃SiCl₃
S-20: CH₂═CHSi(C₂H₅)(OCH₃)₂
S-21: CH₂═C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃)(OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂═C(CH₃)COO(CH₂)₃Si(OC₂H₅)₃
S-31: CH₂═CHCOO(CH₂)₂Si(CH₃)₂(OCH₃)
S-32: CH₂═CHCOO(CH₂)₂Si(CH₃)(OCOCH₃)₂
S-33: CH₂═CHCOO(CH₂)₂Si(CH₃)(ONHCH₃)₂
S-34: CH₂═CHCOO(CH₂)₂Si(CH₃)(OC₆H₅)₂
S-35: CH₂═CHCOO(CH₂)₂Si(C₁₀H₂₁)(OCH₃)₂
S-36: CH₂═CHCOO(CH₂)₂Si(CH₂C₆H₅)(OCH₃)₂

From a viewpoint of enhancing mechanical strength of the protective layer, the content of the metal oxide fine particle in the protective layer is preferably 10 parts by weight or more, more preferably 50 parts by weight or more, and further preferably 100 parts by weight or more, relative to 100 parts by weight of a polymerized product obtained by a radical reaction of the radical polymerizable monomer (hereinafter also referred to as “cured resin”). Meanwhile, in view of stable potential retention of the protective layer, the content is preferably 200 parts by weight or less, more preferably 175 parts by weight or less, and further preferably 150 parts by weight or less, relative to 100 parts by weight of the cured resin.

Camphorquinone or a derivative thereof may be one or more compounds. The camphorquinone derivative may have any molecular structure as long as it has a bicyclo[2.2.1]heptane skeleton and functions as a radical reaction initiator for the radical polymerizable functional group. Examples of the camphorquinone derivatives include a compound having a carboxyl group in place of the methyl group bonded with the carbon at position 1 of camphorquinone. Specifically, examples of camphorquinone and derivatives thereof include camphorquinone, 7,7-dimethyl-2,3-dioxobicyclo[2.2.1]heptane-1-carboxylic acid, 7,7-dimethyl-2,3-dioxobicyclo[2.2.1]heptane-1-carboxylic acid 2-bromoethyl ester and 7,7-dimethyl-2,3-dioxobicyclo[2.2.1]heptane-1-carboxylic acid methyl ester.

Camphorquinone or the derivative thereof itself, or in the form of a reaction product of its hydroxyl radical is incorporated into the protective layer. In view of satisfactory progress of a radical reaction, the content of camphorquinone or the derivative thereof in the protective layer is preferably 3 parts by weight or more, more preferably 5 parts by weight or more, relative to 100 parts by weight of the cured resin. Meanwhile, from a viewpoint of imparting desired hardness to the protective layer, the content is preferably 15 parts by weight or less, more preferably 10 parts by weight or less.

The protective layer may further contain a component other than the above-described ones as a protective layer material, as long as the advantageous effects of the embodiment are obtained. Examples of other components include a tertiary amine compound and a charge transport agent.

The tertiary amine compound functions as a radical reaction promotor in a radical reaction of the radical polymerizable functional group in the presence of camphorquinone or a derivative thereof. The tertiary amine compound may be one or more compounds. The tertiary amine compound preferably has a radical polymerizable functional group, such as an acryloyl group or a methacryloyl group, from a viewpoint of suppressing bleeding out of the tertiary amine compound from the protective layer.

Examples of the tertiary amine compounds include LIGHT ESTER DE (from Kyoeisha Chemical Co., Ltd.) and KAYACURE EPA (from Nippon Kayaku Co., Ltd., “KAYACURE” is a registered trademark of the firm).

From a viewpoint of obtaining the above-mentioned reaction promoting effects, the content of the tertiary amine compound in the protective layer is preferably 20 mass % or more, more preferably 40 mass % or more, based on the amount of camphorquinone or a derivative thereof. Meanwhile, from a viewpoint of imparting desired electric properties to the protective layer, the content is preferably 100 mass % or less, more preferably 80 mass % or less, based on the amount of camphorquinone or a derivative thereof.

The charge transport agent may be one or more compounds. The charge transport agent can be appropriately selected from commonly known charge transport materials contained in a photosensitive layer or a charge transport layer of an electrophotographic photoconductor, and may be a compound described in PTL 1, for example. From a viewpoint of achieving desired electric properties in a photoconductor, the content of the charge transport agent in the protective layer is preferably 25 parts by weight or more, more preferably 40 parts by weight or more, relative to 100 parts by weight of the cured resin. Meanwhile, from a viewpoint of imparting desired strength to the protective layer, the content is preferably 75 parts by weight or less, more preferably 60 parts by weight or less.

The metal oxide of the metal oxide fine particle in the protective layer can be characterized by cross-sectional observation and elemental mapping using a scanning transmission electron microscope (STEM). The content of the metal oxide fine particle can be determined by loss on ignition. Other organic materials of the protective layer can be identified by common instrumental analysis, such as infrared spectroscopy (IR), mass spectrometry (MS), or nuclear magnetic resonance (NMR) after appropriate pretreatment, such as extraction with a solvent.

The photoconductor can be manufactured in substantially the same manner as a commonly known photoconductor except for using suitable materials for the protective layer. The photoconductor can be manufactured, for example, through a method including steps of forming a photosensitive layer on the conductive support and forming the protective layer on the photosensitive layer. The photosensitive layer can be formed by applying a coating material for the photosensitive layer on the conductive support, and solidifying or curing the formed coating film of the coating material.

The protective layer can be formed by forming a coating film of a composition (coating material for protective layer) containing the above-mentioned protective layer materials in the above-described amounts, drying the coating film as needed, and irradiating the coating film with actinic radiation to cure. The content of the radical polymerizable monomer in the protective layer coating material is substantially the same as the content of the above-described polymerized product in the protective layer, and the contents of other material components in the protective layer coating material are substantially the same as those in the protective layer.

The composition may further contain a component other than the above-mentioned protective layer materials as needed. The composition may further contain a solvent, for example.

The solvent may be one or more compounds, and can be appropriately selected from commonly known solvents in view of compatibility with an organic material, for example. Examples of the solvents include methanol, ethanol, n-propyl alcohol, isopropyl alcohol, n-butanol, t-butanol, sec-butanol, benzyl alcohol, toluene, xylene, methylene chloride, methyl ethyl ketone, cyclohexane, ethyl acetate, butyl acetate, methyl cellosolve, ethyl cellosolve, tetrahydrofuran, 1,4-dioxane, 1,3-dioxolane, pyridine, and diethylamine

The solvent content in the protective layer coating material can be appropriately set in view of productivity, and can be set, for example, to an amount such that the concentration (solids concentration) of components other than the solvent in the protective layer coating material becomes 25 to 50 mass %.

The application of the protective layer coating material to the photosensitive layer can be performed by a commonly known method. Examples of such application methods include dip coating, spray coating, spinner coating, bead coating, blade coating, beam coating, slide hopper method, and circular slide hopper method.

The actinic radiation is UV rays or electron beams, for example, and preferably UV rays in view of ease of use. UV light sources can be appropriately selected from light sources that generate UV rays, and the examples include a low-pressure mercury lamp, a high-pressure mercury lamp, an ultra-high-pressure mercury lamp, a carbon arc lamp, a metal halide lamp, a xenon lamp, and a flash (pulsed) xenon lamp. The irradiation dose of the actinic radiation is 5 to 500 mW/cm², for example, and irradiation conditions of the actinic radiation can be appropriately determined corresponding to types of light sources.

The photoconductor is used as an organic photoconductor of an electrophotographic image forming apparatus. The image forming apparatus includes, for example, the photoconductor, a charging device for charging the surface of the photoconductor, an exposing device for forming an electrostatic latent image by irradiating the charged surface of the photoconductor with light, a developing device for supplying a toner to the photoconductor (on which the electrostatic latent image is formed) and forming a toner image, a transfer device for transferring the toner image on the surface of the photoconductor to a recording medium, and a cleaning device for removing residual toner on the surface of the photoconductor after transferring the toner image to the recording medium.

Further, the photoconductor is applied to an image forming method including: supplying a toner to the surface of the photoconductor (on which an electrostatic latent image is formed) so as to form a toner image corresponding to the electrostatic latent image on the surface of the photoconductor; transferring the toner image from the surface of the photoconductor to a recording medium; and removing residual toner on the surface of the photoconductor by a cleaning device. The image forming method is performed, for example, by the above-described image forming apparatus.

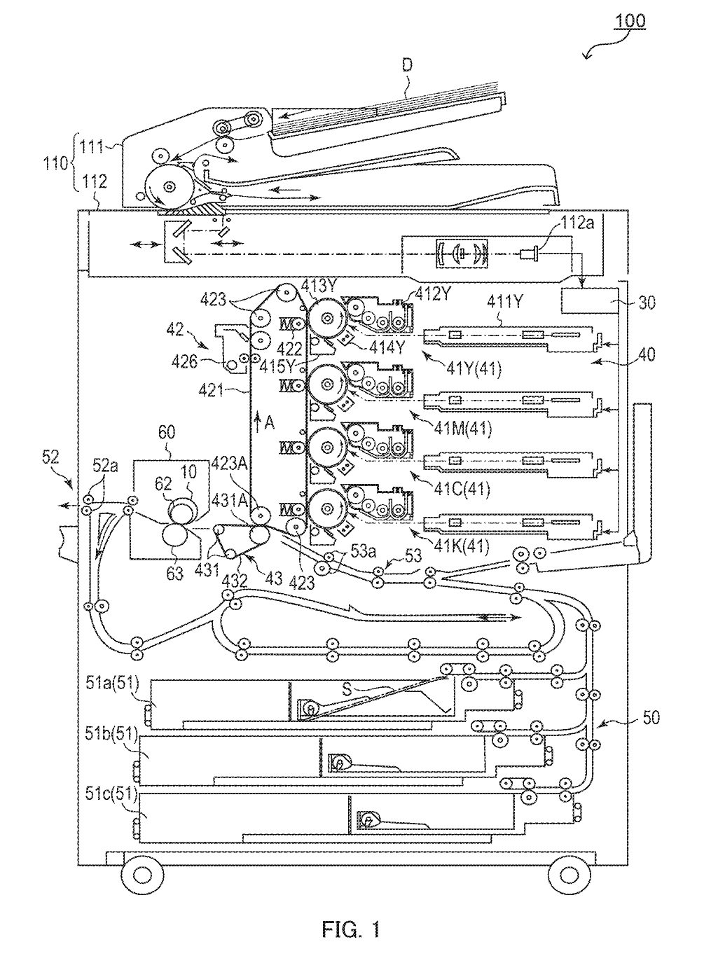

FIG. 1 schematically illustrates an example of a configuration of an image forming apparatus including the above-described photoconductor. Image forming apparatus 100 illustrated in FIG. 1 includes image reading section 110, image processing section 30, image forming section 40, sheet conveying section 50, and fixing device 60.

Image forming section 40 includes image forming units 41Y, 41M, 41C, and 41K that form yellow (Y), magenta (M), cyan (C), and black (K) toner images, respectively. Since these units have substantially the same configurations except for toners to be stored, symbols representing colors will sometimes be omitted hereinafter. Image forming section 40 further includes intermediate transfer unit 42 and secondary transfer unit 43. These units correspond to a transfer device.

Image forming unit 41 includes exposing device 411, developing device 412, photoconductor 413, charging device 414, and drum cleaning device 415.

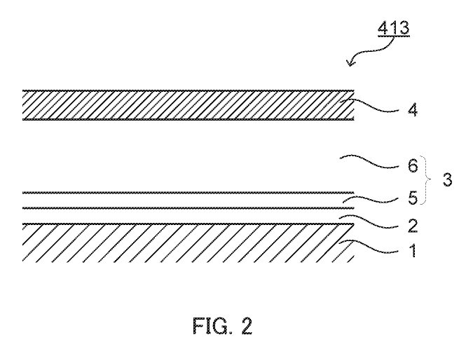

FIG. 2 schematically illustrates an example of a layered structure of the above-described photoconductor. As illustrated in FIG. 2, photoconductor 413 includes conductive support 1, and intermediate layer 2, photosensitive layer 3 and protective layer 4 which are disposed on conductive support 1. Photosensitive layer 3 includes charge generation layer 5 and charge transport layer 6.

Conductive support 1 is an aluminum cylinder, for example. The thickness of the peripheral wall is 0.1 mm, for example. Each layer from intermediate layer 2 to protective layer 4 is disposed on/above the outer peripheral surface of conductive support 1.

Intermediate layer 2 is formed from a binder resin and a conductive particle dispersed therein, for example. The thickness of intermediate layer 2 is, for example, 0.1 to 15 μm, more preferably 0.3 to 10 μm.

Examples of the binder resins include casein, polyvinyl alcohol, nitrocellulose, ethylene-acrylic acid copolymer, a polyamide, a polyurethane, and gelatin. Examples of the conductive particles include metal oxide particles, such as alumina, zinc oxide, titanium oxide, tin oxide, antimony oxide, indium oxide, and bismuth oxide; and ultrafine particles, such as tin-doped indium oxide, antimony-doped tin oxide, and zirconium oxide. Intermediate layer 2 is formed, for example, by dip coating, i.e., dipping conductive support 1 in a solution of the binder resin in which the conductive particle is dispersed.

Charge generation layer 5 is formed from a binder resin and a charge generation material dispersed therein, for example. The thickness of charge generation layer 5 is, for example, 0.01 to 5 μm, more preferably 0.05 to 3 μm.

Examples of the binder resins include polystyrene, polyethylene, polypropylene, an acrylic resin, a methacrylic resin, polyvinyl chloride resin, a vinyl acetate resin, polyvinyl butyral, an epoxy resin, a polyurethane, a phenolic resin, a polyester, an alkyd resin, a polycarbonate, a silicone resin, a melamine resin, a copolymer containing two or more of these resins (vinyl chloride-vinyl acetate copolymer, and vinyl chloride-vinyl acetate-maleic anhydride copolymer, for example), and polyvinylcarbazole. Examples of the charge generation materials include azo pigments, such as Sudan Red and Diane Blue; quinone pigments, such as pyrenequinone and anthanthrone; quinocyanine pigments; perylene pigments; indigo pigments, such as indigo and thioindigo; and phthalocyanine pigments. Charge generation layer 5 is also formed, for example, by dip coating through dipping conductive support 1 (on which intermediate layer 2 is formed) in a solution of the binder resin in which the charge generation material is dispersed.

Charge transport layer 6 is formed from a binder resin and a charge transport material dispersed therein, for example. The thickness of charge transport layer 6 is, for example, 5 to 40 μm, more preferably 10 to 30 μm.

Examples of the binder resins include a polycarbonate resin, a polyacrylate resin, a polyester resin, polystyrene resin, styrene-acrylonitrile copolymer resin, a polymethaciylate ester resin, and styrene-methacrylate ester copolymer resin. Examples of the charge transport materials include, in addition to the above-mentioned charge transport compounds, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styiyl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triarylamine derivatives, phenylenediamine derivatives, stilbene derivatives, benzidine derivatives, poly(N-vinylcarbazole), poly(1-vinylpyrene), and poly(1-vinylanthracene). Charge transport layer 6 is also formed, for example, by dip coating through dipping conductive support 1 (on which charge generation layer 5 is formed) in a solution of the charge transport material and the binder resin.

Protective layer 4 is a cylindrical thin film formed as one body by curing (polymerization reaction) of a coating film of the above-mentioned protective layer coating material. The thickness of protective layer 4 is, for example, 2 to 15 μm, more preferably 4 to 8 μm. Protective layer 4 is also formed, for example, by dip coating through dipping conductive support 1 (on which charge transport layer 6 is formed) in the protective layer coating material.

Charging device 414 is a corona charger, for example. Charging device 414 may be a contact charging device that charges photoconductor 413 by bringing a contact charging member, such as a charging roller, a charging brush, or a charging blade, into contact with photoconductor 413. Exposing device 411 includes, for example, a semiconductor laser as a light source and an optical deflector (polygon motor) that directs a laser beam corresponding to an image to be formed toward photoconductor 413 and irradiates photoconductor 413 with the laser beam.

Developing device 412 is a developing device of a two-component developing system. Developing device 412 includes, for example, a developer container that stores a two-component developer, developing roller (magnetic roller) rotatably disposed in the opening of the developer container, a partition wall that divides inside the developer container such that the two-component developer passes through the partition wall, a conveyance roller for conveying the two-component developer on the opening side of the developer container toward the developing roller, and stirring roller for stirring the two-component developer inside the developer container. In the developer container, for example, a two-component developer described hereinafter is stored.

Drum cleaning device 415 includes a drum cleaning blade disposed so as to slide on the surface of photoconductor 413, and cleaning container that supports the blade in the opening. The cleaning blade is a cleaning member, and an elastic sheet member (rubber sheet or the like), for example. The cleaning member may be an elastic member that is disposed so that it can come into contact with the surface of photoconductor 413, and may be a flexible brush.

Intermediate transfer unit 42 includes intermediate transfer belt 421, primary transfer roller 422 that firmly presses intermediate transfer belt 421 against photoconductor 413, a plurality of support rollers 423 including backup roller 423A, and belt cleaning device 426. Intermediate transfer belt 421 is looped around a plurality of support rollers 423 under tension. Intermediate transfer belt 421 runs in arrow A direction at a constant speed by the rotation of at least one driving roller among a plurality of support rollers 423.

Secondary transfer unit 43 includes endless secondary transfer belt 432, and a plurality of support rollers 431 including secondary transfer roller 431A. Secondary transfer belt 432 is looped around secondary transfer roller 431A and support rollers 431 under tension.

Fixing device 60 includes, for example, fixing roller 62, endless heating belt 10 that covers the outer peripheral surface of fixing roller 62 for heating/melting a toner that forms a toner image on sheet S, and pressure roller 63 that presses sheet S against fixing roller 62 and heating belt 10. Sheet S corresponds to a recording medium.

Image reading section 110 includes sheet feeding device 111 and scanner 112. Sheet conveying section 50 includes sheet feeding section 51, sheet ejection section 52, and conveying path section 53. Three sheet feeding tray units 51a to 51c, which constitute sheet feeding section 51, store sheets S classified based on basis weight, size, or the like (standard paper, special paper) in accordance with predetermined types. Conveying path section 53 includes a plurality of conveying roller pairs, such as registration roller pair 53a.

Image formation by image forming apparatus 100 will be described.

Scanner 112 optically scans and reads document D on a contact glass. The reflected light from document D is read by CCD sensor 112a as input image data. The input image data undergoes predetermined image processing in image processing section 30, and is transmitted to exposing device 411.

Photoconductor 413 rotates at a constant peripheral speed. Charging device 414 evenly and negatively charges the surface of photoconductor 413. In exposing device 411, a polygon mirror of the polygon motor rotates at a high speed, thereby spreading a laser beam corresponding to input image data of each color component along the axial direction of photoconductor 413 while irradiating the outer peripheral surface of photoconductor 413 along the axial direction. Accordingly, an electrostatic latent image is formed on the surface of photoconductor 413.

In developing device 412, a toner particle is charged through stirring/conveying of a two-component developer inside the developer container, and the two-component developer conveyed to the developing roller forms a magnetic brush on the surface of the developing roller. The charged toner particle is electrostatically attached, from the magnetic brush, to a portion of photoconductor 413 corresponding to an electrostatic latent image. The electrostatic latent image on the surface of photoconductor 413 is thus visualized, forming a toner image corresponding to the electrostatic latent image on the surface of photoconductor 413. As used herein, “toner image” refers to an aggregated state of a toner as an image.

The toner image on the surface of photoconductor 413 is transferred to intermediate transfer belt 421 by intermediate transfer unit 42. Transfer residual toner remaining on the surface of photoconductor 413 after transfer is scraped by a drum cleaning blade that is slid on the surface of photoconductor 413, and stored in the cleaning container. Transfer residual toner on the surface of photoconductor 413 is thus removed by drum cleaning device 415.

Photoconductor 413 includes protective layer 4 that contains a metal oxide fine particle and is formed from a polymerized product as one body obtained by a radical polymerization. This suppresses wear of protective layer 4, and consequently photoconductor 413 exhibits desired performance over a long period of time.

Further, the rotational torque of photoconductor 413 is stable over a long period of time. This is presumably due to the following.

When a protective layer of a photoconductor contains a metal oxide fine particle, the elasticity of the protective layer generally becomes higher than that of a protective layer solely formed from a thermosetting resin. As a result, a low-molecular component in the protective layer, such as a byproduct of a polymerization initiator decomposed during a polymerization process, readily bleeds out, and consequently frictional force between the protective layer and the cleaning blade tends to become large. Further, when a protective layer containing a metal oxide fine particle is formed by a radical photopolymerization, unevenness (curing unevenness) in the polymerization reaction of a radical polymerizable monomer within the protective layer tends to become severe. Accordingly, a low-molecular component, such as the byproduct or unreacted above-described monomers, bleeds out of the photoconductor, thereby increasing the above-described frictional force as well as rotational torque of the photoconductor over time, and consequently cleaning failure sometimes results therefrom.

Meanwhile, protective layer 4 of photoconductor 413 of the embodiment contains camphorquinone or a derivative thereof. Camphorquinone or a derivative thereof functions as a photopolymerization initiator for a radical polymerizable monomer that forms a polymerized product constituting protective layer 4.

Camphorquinone or a derivative thereof has a bicycle[2.2.1]heptane skeleton. Due to the stiff structure, it is believed that the elasticity of protective layer 4 lowers relative to that of a protective layer containing a photopolymerization initiator having another structure, and consequently the rotational torque also lowers.

Further, camphorquinone or a derivative thereof exhibits a smaller structural change before and after polymerization initiation than that of other photopolymerization initiators, such as a cleavage-type polymerization initiator. Due to this, bleeding out of protective layer 4 is presumably also suppressed.

Camphorquinone or a derivative thereof is a photopolymerization initiator that has absorption in the visible light region. Due to this, camphorquinone or a derivative thereof is insusceptible to light scattering by the metal oxide fine particle. As a result, evenness in the polymerization reaction (curing) of the radical polymerizable monomer is presumably enhanced.

A primary transfer nip is formed for every photoconductor between photoconductor 413 and intermediate transfer belt 421 through firmly pressing intermediate transfer belt 421 against photoconductor 413 by primary transfer roller 422. At the primary transfer nips, toner images of respective colors are successively superimposed and transferred to intermediate transfer belt 421.

Meanwhile, secondary transfer roller 431A is firmly pressed against backup roller 423A via intermediate transfer belt 421 and secondary transfer belt 432. Accordingly, a secondary transfer nip is formed between intermediate transfer belt 421 and secondary transfer belt 432. Sheet S passes through the secondary transfer nip. Sheet S is conveyed to the secondary transfer nip by sheet conveying section 50. Registration roller section, in which registration roller pair 53a is arranged, corrects the tilt of sheet S and adjusts the timing of conveyance.

When sheet S is conveyed to the secondary transfer nip, transfer bias is applied to secondary transfer roller 431A. By the application of transfer bias, a toner image borne by intermediate transfer belt 421 is transferred to sheet S. Sheet S bearing the transferred toner image is conveyed to fixing device 60 by secondary transfer belt 432.

Fixing device 60 forms a fixing nip by heating belt 10 and pressure roller 63, and heats/presses conveyed sheet S at the fixing nip. The toner image is thus fixed on sheet S. Sheet S bearing the fixed toner image is ejected outside the apparatus by sheet ejection section 52 equipped with sheet ejection rollers 52a.

Transfer residual toner remaining on the surface of intermediate transfer belt 421 after secondary transfer is removed by belt cleaning device 426 including a belt cleaning blade that is slid on the surface of intermediate transfer belt 421.

As mentioned above, the rotational torque is stable over a long period of time due to high wear resistance of protective layer 4 and suppressed increase in rotational torque of photoconductor 413. Accordingly, stable cleaning is performed for photoconductor 413 over a long period of time, and consequently image forming apparatus 100 can form, over a long period of time, high-quality images without image defects caused by cleaning failure.

As is evident from the above description, the photoconductor of the embodiment includes: a conductive support; a photosensitive layer disposed on the conductive support; and a protective layer disposed on the photosensitive layer, in which the protective layer is composed of a cured product as one body obtained by a radical reaction of a composition containing: a radical polymerizable monomer having a radical polymerizable functional group; a metal oxide fine particle having a radical polymerizable functional group; and camphorquinone or a derivative thereof. Accordingly, the photoconductor has both excellent wear resistance and excellent cleaning properties.

The composition further containing a tertiary amine compound is more effective, from a viewpoint of enhancing mechanical strength of the protective layer.

The protective layer further containing a charge transport agent is more effective, from a viewpoint of enhancing electric properties of the photoconductor.

The image forming apparatus of the embodiment includes: the above-described photoconductor; and a cleaner for removing transfer residual toner on the surface of the photoconductor, in which the cleaner includes an elastic material that comes into contact with the surface of the photoconductor. Accordingly, the image forming apparatus can achieve long-term stable formation of high-quality images.

### EXAMPLES

[Preparation of Component Materials]

As “camphorquinone or a derivative thereof” of the present invention, compounds CQ-1 to CQ-4 were prepared.

CQ-1: camphorquinone
CQ-2: 7,7-dimethyl-2,3-dioxobicyclo[2.2.1]heptane-1-carboxylic acid
CQ-3: 7,7-dimethyl-2,3-dioxobicyclo[2.2.1]heptane-1-carboxylic acid 2-bromoethyl ester
CQ-4: 7,7-dimethyl-2,3-dioxobicyclo[2.2.1]heptane-1-carboxylic acid methyl ester

As “charge transport agent” of the present invention, compounds CTM-1 and CTM-2 were prepared.

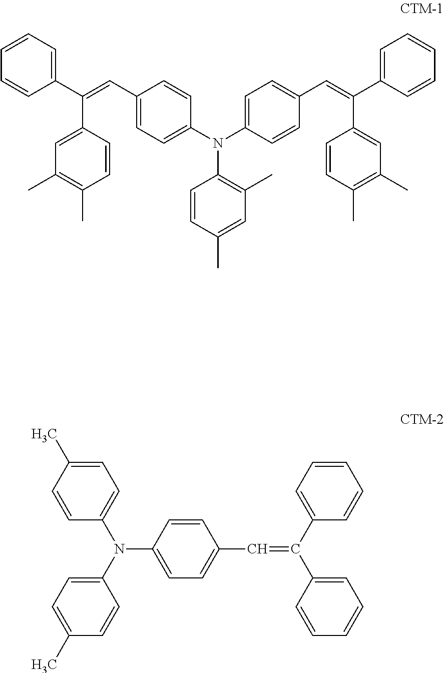 [SMILES: Cc1ccc(N(c2ccc(/C=C(/c3ccccc3)c3ccc(C)c(C)c3)cc2)c2ccc(/C=C(/c3ccccc3)c3ccc(C)c(C)c3)cc2)c(C)c1 ; Cc1ccc(N(c2ccc(C)cc2)c2ccc(C=C(c3ccccc3)c3ccccc3)cc2)cc1]

Further, as “tertiary amine compound” of the present invention, compounds A-1 and A-2 were prepared. A-1 is “LIGHT ESTER DE” (from Kyoeisha Chemical Co., Ltd.) and A-2 is “KAYACURE EPA” (from Nippon Kayaku Co., Ltd.).

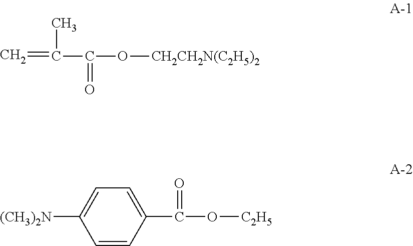

### Example 1

[Preparation of Conductive Support]

As a conductive support, a drum-shaped (cylindrical) aluminum support (outer diameter 60 mm) was prepared.

[Formation of Intermediate Layer]

Into 1700 parts by weight of a mixed solvent composed of ethanol/n-propyl alcohol/tetrahydrofuran (volume ratio of 45/20/35), 100 parts by weight of a polyamide resin as a binder resin for an intermediate layer was added, and stirred/mixed at 20° C. to yield solution A. Into solution A, 160 parts by weight of “SMT 500SAS” titanium oxide particles (from Tayca Corporation) and 120 parts by weight of “SMT 150MK” titanium oxide particles (from Tayca Corporation) were added, and dispersed using a bead mill for a mill residence time of 5 hours.

An intermediate layer coating material was obtained by allowing the resulting dispersion to stand still for one day, and then filtering. The filtering was performed using a Rigimesh filter with a nominal removal rating of 5 μm (from Pall Corporation) under a pressure of 50 kPa. The intermediate layer coating material thus-obtained was applied on the outer peripheral surface of the washed conductive support by dip coating, and dried at 120° C. for 30 minutes to form an intermediate layer having a dry thickness of 2 μm.

[Formation of Charge Generation Layer]

A charge generation layer coating material was prepared by dispersing the following components in the following amounts using a sand mill as a disperser.

γ-Titanyl phthalocyanine 20 parts by weight
Polyvinyl butyral 10 parts by weight
Methyl ethyl ketone 700 parts by weight
Cyclohexanone 300 parts by weight

“γ-Titanyl phthalocyanine” is a charge generation material as well as a titanyl phthalocyanine pigment having a maximum diffraction peak at a Bragg angle (20±0.2°) of 27.3° in x-ray spectrum using a Cu-Kα characteristic x-ray. The “polyvinyl butyral” is a binder resin for a charge generation layer, and is “BX-1” (from Sekisui Chemical Co., Ltd.). Both “methyl ethyl ketone” and “cyclohexanone” are solvents.

A charge generation layer having a dry thickness of 0.3 μm was formed by applying the charge generation layer coating material on the intermediate layer by dip coating and forming a coating film.

[Formation of Charge Transport Layer]

A charge transport layer coating material was prepared by mixing and dissolving the following components in the following amounts.

| | | |
|---|---|---|
| Charge transport material | 225 | parts by weight |
| Polycarbonate resin | 300 | parts by weight |
| Tetrahydrofuran | 1,600 | parts by weight |
| Toluene | 400 | parts by weight |
| Dibutylhydroxytoluene | 6 | parts by weight |
| Silicone oil | 1 | part by weight |

The “charge transport material” is 4,4′-dimethyl-4″-(β-phenylstyryl)triphenylamine. The “polycarbonate” is a binder resin for a charge transport layer, and is “Z 300” (from Mitsubishi Gas Chemical Company, Inc.). Both “tetrahydrofuran” and “toluene” are solvents. “Dibutylhydroxytoluene” is an antioxidant. The silicone oil is “KF-96” (from Shin-Etsu Chemical Co., Ltd.).

A charge transport layer having a thickness of 20 ium was formed by applying the charge transport layer coating material on the charge generation layer by dip coating and forming a coating film.

As described above, manufactured was a photoconductor precursor having, on the outer peripheral surface of the conductive support, the intermediate layer, and a photosensitive layer including the charge generation layer and the charge transport layer in this order.

[Formation of Protective Layer]

Protective layer coating material 1 was prepared by mixing/stirring the following components in the following amounts so as to dissolve/disperse the components satisfactorily.

| | | |
|---|---|---|
| Polymerizable compound M1 | 100 | parts by weight |
| Surface-treated metal oxide fine particle 1 | 68 | parts by weight |
| CQ-1 | 7.5 | parts by weight |
| 2-Butanol | 230 | parts by weight |
| Tetrahydrofuran | 12 | parts by weight |

“Polymerizable compound M1” is a radical polymerizable monomer and is a compound represented by formula M1 among the compound group illustrated as the monomers. “Surface-treated metal oxide fine particle 1” is a silica particle surface-treated with a silane coupling agent represented by formula S-15 among the silane coupling agent group illustrated as the surface treatment agents. The “silica particle” is “Aerosil 130” (average particle size: 20 nm, from Nippon Aerosil Co., Ltd.). As mentioned above, “CQ-1” corresponds to “camphorquinone or a derivative thereof” and is a polymerization initiator. Both “2-butanol” and “tetrahydrofuran” are solvents.

Protective layer 1 having a thickness of 1 μm was formed by applying protective layer coating material 1 on the charge transport layer of the photoconductor precursor using a circular slide hopper coater, irradiating with a UV ray at an irradiance of 16 mW/cm² using a xenon lamp, and then drying at 80° C. for 70 minutes. Photoconductor 1 was thus manufactured.

### Example 2

Protective layer coating material 2 was prepared in substantially the same manner as protective layer coating material 1 except for changing the amount of surface-treated metal oxide fine particle 1 to 54 parts by weight and the amount of CQ-1 to 8 parts by weight, and further adding 44 parts by weight of charge transport agent CTM-1. Protective layer 2 having a thickness of 3 μm was formed on the charge transport layer of the photoconductor precursor in substantially the same manner as Example 1 except for using protective layer coating material 2 in place of protective layer coating material 1. Photoconductor 2 was thus manufactured.

### Example 3

Protective layer coating material 3 was prepared in substantially the same manner as protective layer coating material 1 except for changing the amount of surface-treated metal oxide fine particle 1 to 39 parts by weight and the amount of CQ-1 to 6 parts by weight, and further adding 1.4 parts by weight of tertiary amine A-1. Protective layer 3 having a thickness of 1 μm was formed on the charge transport layer of the photoconductor precursor in substantially the same manner as Example 1 except for using protective layer coating material 3 in place of protective layer coating material 1. Photoconductor 3 was thus manufactured.

### Example 4

Protective layer coating material 4 was prepared in substantially the same manner as protective layer coating material 3 except for using surface-treated metal oxide fine particle 2 in place of surface-treated metal oxide fine particle 1. Protective layer 4 having a thickness of 3 μm was formed on the charge transport layer of the photoconductor precursor in substantially the same manner as Example 3 except for using protective layer coating material 4 in place of protective layer coating material 3. Photoconductor 4 was thus manufactured.

“Surface-treated metal oxide fine particle 2” is a tin oxide particle surface-treated with a silane coupling agent represented by formula S-15. The “tin oxide particle” is “NanoTek SnO₂” (average particle size: 21 nm, from CIK Nanotek Corporation, “NanoTek” is a registered trademark of the firm).

### Example 5

Protective layer coating material 5 was prepared in substantially the same manner as protective layer coating material 2 except for changing the amount of CTM-1 to 43.5 parts by weight and further adding 2.0 parts by weight of tertiary amine A-1. Protective layer 5 having a thickness of 3 μm was formed on the charge transport layer of the photoconductor precursor in substantially the same manner as Example 1 except for using protective layer coating material 5 in place of protective layer coating material 2. Photoconductor 5 was thus manufactured.

### Example 6

Protective layer coating material 6 was prepared in substantially the same manner as protective layer coating material 5 except for using CTM-2 in place of CTM-1. Protective layer 6 having a thickness of 3 μm was formed on the charge transport layer of the photoconductor precursor in substantially the same manner as Example 5 except for using protective layer coating material 6 in place of protective layer coating material 5. Photoconductor 6 was thus manufactured.

### Examples 7 to 10

Protective layers 7 to 10 having a thickness of 1 μm were each formed on the charge transport layer of the photoconductor precursor in substantially the same manner as Example 1 except for using respective protective layer coating materials 7 to 10 in place of protective layer coating material 1. Each of photoconductors 7 to 10 was thus manufactured.

Protective layer coating material 7 was prepared in substantially the same manner as protective layer coating material 1 except for using polymerizable compound M2 in place of polymerizable compound M1 and using surface-treated metal oxide fine particle 3 in place of surface-treated metal oxide fine particle 1. “Polymerizable compound M2” is a radical polymerizable monomer and is a compound represented by formula M2 among the compound group illustrated as the monomers. “Surface-treated metal oxide fine particle 3” is an “Aerosil 130” silica particle (average particle size: 20 nm, from Nippon Aerosil Co., Ltd.) surface-treated with a silane coupling agent represented by formula S-7 among the silane coupling agent group illustrated as the surface treatment agents.

Protective layer coating materials 8 and 9 were each prepared in substantially the same manner as protective layer coating material 1 except for using respective CQ-2 and CQ-3 in place of CQ-1. Protective layer coating material 10 was prepared in substantially the same manner as protective layer coating material 1 except for using surface-treated metal oxide fine particle 4 in place of surface-treated metal oxide fine particle 1, and using CQ-4 in place of CQ-1. “Surface-treated metal oxide fine particle 4” is an alumina particle surface-treated with a silane coupling agent represented by formula S-15. The “alumina particle” is “NanoTek Al₂O₃” (average particle size: 30 nm, from CIK Nanotek Corporation, “NanoTek” is a registered trademark of the firm). As mentioned above, “CQ-2,” “CQ-3,” and “CQ-4” each correspond to “camphorquinone or a derivative thereof,” and are polymerization initiators.

### Example 11

Protective layer coating material 11 was prepared in substantially the same manner as protective layer coating material 2 except for using CTM-2 in place of CTM-1. Protective layer 11 having a thickness of 3 μm was formed on the charge transport layer of the photoconductor precursor in substantially the same manner as Example 2 except for using protective layer coating material 11 in place of protective layer coating material 2. Photoconductor 11 was thus manufactured.

### Example 12

Protective layer coating material 12 was prepared in substantially the same manner as protective layer coating material 3 except for using tertiary amine A-2 in place of tertiary amine A-1. Protective layer 12 having a thickness of 1 μm was formed on the charge transport layer of the photoconductor precursor in substantially the same manner as Example 3 except for using protective layer coating material 12 in place of protective layer coating material 3. Photoconductor 12 was thus manufactured.

### Example 13

Protective layer coating material 13 was prepared in substantially the same manner as protective layer coating material 5 except for using CQ-2 in place of CQ-1, using CTM-2 in place of CTM-1, and using tertiary amine A-2 in place of tertiary amine A-1. Protective layer 15 having a thickness of 3 μm was formed on the charge transport layer of the photoconductor precursor in substantially the same manner as Example 5 except for using protective layer coating material 13 in place of protective layer coating material 5. Photoconductor 15 was thus manufactured.

### Comparative Examples 1 to 4

Protective layers 14 to 17 having a thickness of 1 μm or 3 μm were each formed on the charge transport layer of the photoconductor precursor in substantially the same manner as Examples 1, 2, 3, and 5, respectively, except for using respective protective layer coating materials 14 to 17 in place of protective layer coating material 1. Each of photoconductors 14 to 17 was thus manufactured.

Protective layer coating material 14 was prepared in substantially the same manner as protective layer coating material 1 except for using Irgacure 184 in place of CQ-1. Protective layer coating material 15 was prepared in substantially the same manner as protective layer coating material 2 except for using Irgacure 127 in place of CQ-1. Protective layer coating material 16 was prepared in substantially the same manner as protective layer coating material 3 except for using Irgacure 379 in place of CQ-1. Protective layer coating material 17 was prepared in substantially the same manner as protective layer coating material 5 except for using Irgacure 369 in place of CQ-1. “Irgacure 184,” “Irgacure 127,” “Irgacure 379,” and “Irgacure 369” are available from BASF SE (“Irgacure” is a registered trademark of the firm) and polymerization initiators that do not correspond to camphorquinone or a derivative thereof.

Table 1 shows materials for and thickness of the protective layers of photoconductors 1 to 17.

TABLE 1
Table 1

| | | Protective Layer | | | | | | |
|---|---|---|---|---|---|---|---|---|
| | | | Metal Oxide Fine Particle | | | Charge | | |
| | Photoconductor | | Metal | Surface | Polymerization | Transport | Tertiary | Thickness |
| | No. | Monomer | Oxide | Treatment Agent | Initiator | Agent | Amine | (μm) |
| Ex. 1 | 1 | M1 | SiO₂ | S-15 | CQ-1 | — | — | 1 |
| Ex. 2 | 2 | M1 | SiO2 | S-15 | CQ-1 | CTM-1 | — | 3 |
| Ex. 3 | 3 | M1 | SiO2 | S-15 | CQ-1 | — | A-1 | 1 |
| Ex. 4 | 4 | M1 | SnO2 | S-15 | CQ-1 | — | A-1 | 3 |
| Ex. 5 | 5 | M1 | SiO2 | S-15 | CQ-1 | CTM-1 | A-1 | 3 |
| Ex. 6 | 6 | M1 | SiO2 | S-15 | CQ-1 | CTM-2 | A-1 | 3 |
| Ex. 7 | 7 | M2 | SiO2 | S-7 | CQ-1 | — | — | 1 |
| Ex. 8 | 8 | M1 | SiO2 | S-15 | CQ-2 | — | — | 1 |
| Ex. 9 | 9 | M1 | SiO2 | S-15 | CQ-3 | — | — | 1 |
| Ex. 10 | 10 | M1 | Al₂O₃ | S-15 | CQ-4 | — | — | 1 |
| Ex. 11 | 11 | M1 | SiO2 | S-15 | CQ-1 | CTM-2 | — | 3 |
| Ex. 12 | 12 | M1 | SiO2 | S-15 | CQ-1 | — | A-2 | 1 |
| Ex. 13 | 13 | M1 | SiO2 | S-15 | CQ-2 | CTM-2 | A-2 | 3 |
| Comp. Ex. 1 | 14 | M1 | SiO2 | S-15 | Irgacure184 | — | — | 1 |
| Comp. Ex. 2 | 15 | M1 | SiO2 | S-15 | Irgacure 127 | CTM-1 | — | 3 |
| Comp. Ex. 3 | 16 | M1 | SiO2 | S-15 | Irgacure 379 | — | A-1 | 1 |
| Comp. Ex. 4 | 17 | M1 | SiO2 | S-15 | Irgacure 369 | CTM-1 | A-1 | 3 |

[Evaluation]

An endurance test was performed by installing each of photoconductors 1 to 17 in “bizhub PRESS C1070” (from Konica Minolta, Inc., “bizhub” is a registered trademark of the firm) basically having the configuration of FIG. 1, and continuously printing character images (image area ratio of 6% per side) on 500,000 sheets of standard paper by duplex printing (A4 long-edge feed) under an environment at 23° C. and 50% RH.

(1) Cleaning Properties

During and after the endurance test, output images were observed and evaluated in accordance with the following criteria.

A: Excellent without slipping through of toner during printing on 500,000 sheets
B: Sufficient for practical use with satisfactory output images during printing on 500,000 sheets even though slipping through of toner on photoconductor was partially observed
C: Clear streak-like image defects on output images due to slipping through of toner before printing on 500,000 sheets (practically problematic)

(2) Wear Resistance

Wear resistance was evaluated by measuring the thickness of the layered structure (intermediate layer, charge generation layer, charge transport layer, and protective layer) on the conductive support before and after the endurance test, obtaining an amount of wear loss of the layered structure in the endurance test, and obtaining an a value representing an amount of wear loss (μm) per 100,000 rotations (100 krot). An a value of 0.2 μm or less is deemed satisfactory in the present invention.

The amount of wear loss of the layered structure corresponds to the amount of wear loss of the protective layer. The thickness of the layered structure is an average value of measured values at 10 points randomly selected in a uniform-thickness portion of the layered structure. The thickness of the layered structure was measured using an eddy current-mode thickness measurement instrument (trade name: “EDDY560C,” from HELMUT FISCHER GmbH). The “uniform-thickness portion” is a portion excluding varied-thickness portions, which are front and rear end portions in application of a coating material during formation of each layer of the layered structure. The varied-thickness portions are identified through creating a thickness profile of the layered structure in the axial direction of the photoconductor.

Table 2 shows the evaluation results of photoconductors 1 to 17.

TABLE 2
Table 2

| | Photoconductor | Cleaning | α value |
|---|---|---|---|
| | No. | Properties | (μm) |
| Ex. 1 | 1 | B | 0.11 |
| Ex. 2 | 2 | A | 0.18 |
| Ex. 3 | 3 | A | 0.15 |
| Ex. 4 | 4 | A | 0.08 |
| Ex. 5 | 5 | A | 0.15 |
| Ex. 6 | 6 | A | 0.05 |
| Ex. 7 | 7 | A | 0.11 |
| Ex. 8 | 8 | B | 0.11 |
| Ex. 9 | 9 | A | 0.11 |
| Ex. 10 | 10 | A | 0.13 |
| Ex. 11 | 11 | A | 0.13 |
| Ex. 12 | 12 | A | 0.15 |
| Ex. 13 | 13 | A | 0.09 |
| Comp. Ex. 1 | 14 | C | 0.33 |
| Comp. Ex. 2 | 15 | C | 0.20 |
| Comp. Ex. 3 | 16 | C | 0.30 |
| Comp. Ex. 4 | 17 | C | 0.20 |

As is clear from Table 2, photoconductors 1 to 13 exhibited results without practical problem in both cleaning properties and wear resistance.

In contrast, photoconductors 14 to 17 exhibited unsatisfactory cleaning properties and high a values. This is presumably because residual polymerization initiator or a component derived therefrom in the protective layer bleeds out of the protective layer over time during the use under endurance conditions, thereby increasing frictional force between the photoconductor and the cleaning blade as well as increasing the driving torque of the photoconductor. As a result, the protective layer becomes more susceptible to wear and good contact state of the cleaning blade with the protective layer becomes difficult to be maintained. Therefore, cleaning properties are presumably deteriorated.

Although embodiments of the present invention have been described and illustrated in detail, it is clearly understood that the same is by way of illustration and example only and not limitation, the scope of the present invention should be interpreted by terms of the appended claims

### INDUSTRIAL APPLICABILITY

According to the present invention, electrophotographic image formation using an organic photoconductor can achieve long-term stable rotational driving of the photoconductor as well as long-term stable formation of high-quality images since the photoconductor has stable cleaning properties and wear resistance over a long period of time. According to the present invention, further advancement in performance and further widespread use of an electrophotographic image forming apparatus can be expected.

What is claimed is:

1. An electrophotographic photoconductor comprising: a conductive support; a photosensitive layer disposed on the conductive support; and a protective layer disposed on the photosensitive layer, wherein
the protective layer is composed of a cured product as one body obtained by a radical reaction of a composition containing: a radical polymerizable monomer having a radical polymerizable functional group; a metal oxide fine particle having a radical polymerizable functional group; and camphorquinone or a derivative thereof.

2. The electrophotographic photoconductor according to claim 1, wherein the composition further contains a tertiary amine compound.

3. The electrophotographic photoconductor according to claim 1, wherein the protective layer further contains a charge transport agent.

4. An image forming apparatus comprising: the electrophotographic photoconductor according to claim 1; and
a cleaner for removing a transfer residual toner on a surface of the electrophotographic photoconductor, wherein the cleaner includes an elastic material that comes into contact with the surface of the electrophotographic photoconductor.
